(19) United States
(12) Patent Application Publication
(10) Pub. No.: US 2011/0292961 A1
(43) Pub. Date: Dec. 1, 2011

(54) METHOD AND DEVICE FOR CONTROLLING A CARBON MONOXIDE OUTPUT OF AN ELECTRIC ARC LIGHT OVEN

(76) Inventors: Thomas Matschullat, Eckental (DE); Detlef Rieger, Baldham (DE)

(21) Appl. No.: 13/147,654

(22) PCT Filed: Jul. 30, 2009
(86) PCT No.: PCT/EP2009/059873

§ 371 Date: Aug. 3, 2011

(30) Foreign Application Priority Data
Feb. 3, 2009 (DE) 10 2009 007 575.5

(51) Int. Cl. H05B 7/18

(52) U.S. Cl. 373/60

(57) ABSTRACT

In a method and a device for controlling a carbon monoxide output of an electric arc oven, comprising an oven container, an arrangement for determining a height of a foamed slag in at least three zones of the oven container on the basis of a solid-borne sound measurement, at least one first device for controlling an oxygen infeed, and at least one second device for controlling a carbon infeed into the oven container, the height of the foamed slag is determined in each of the at least three zones and associated with a carbon monoxide content in the exhaust gas of the electric arc oven, wherein the carbon infeed and/or the oxygen infeed in at least one of the at least three zones is controlled such that the height of the foamed slag is maintained below a maximum value.

### CROSS-REFERENCE TO RELATED APPLICATIONS

This application is a U.S. National Stage Application of International Application No. PCT/EP2009/059873 filed Jul. 30, 2009, which designates the United States of America, and claims priority to German Application No. 10 2009 007 575.5 filed Feb. 3, 2009, the contents of which are hereby incorporated by reference in their entirety.

### TECHNICAL FIELD

The invention relates to a process and an apparatus for controlling a carbon monoxide emission of an electric arc furnace during operation thereof, which comprises a furnace vessel, an arrangement for determining a height of a foamed slag in at least three zones of the furnace vessel on the basis of a structure-borne noise measurement, at least one first device for controlling a supply of oxygen, and at least one second device for controlling an introduction of carbon into the furnace vessel.

### BACKGROUND

The production of steel in an electric arc furnace involving the melting of scrap generally produces foamed slag on the metal melt formed. This results from an addition of carbon into the furnace vessel for reducing the melt and of oxygen into the furnace vessel for decarburizing the melt. Here, the introduction of carbon can be effected by the addition of batch coal, i.e. lump coal, having a diameter in the range of several millimeters up to a plurality of centimeters, together with the scrap, or by the additional injection of carbon into the furnace vessel onto the surface of the metal melt and/or slag. Some of the carbon required is frequently also introduced by the scrap itself. The scrap used is finally present in a molten state in the furnace vessel, and the batch coal which is possibly present dissolves in the course of the melting process in the melt. The carbon present in dissolved form in the melt is available as a reaction partner for oxygen injected into the furnace vessel, in which case carbon monoxide (CO) and carbon dioxide (CO₂) form, leading to the formation of foamed slag on the surface of the metal melt.

Since a large quantity of carbon is present in dissolved form in the melt after the scrap has been melted, the injection of the oxygen results in the formation of a quantity of foamed slag which often exceeds a reasonable level. The height of the foamed slag which is established in the furnace vessel is therefore usually monitored.

EP 0 637 634 A1 describes a process for producing a metal melt in an electric arc furnace, wherein the height of the foamed slag is determined via a level measurement.

DE 10 2005 034 409 B3 describes a further arrangement for determining the height of a foamed slag in the furnace vessel of an electric arc furnace. Here, the height of a foamed slag is determined in at least three zones of the furnace vessel on the basis of a structure-borne noise measurement.

In order to control the height of the foamed slag on the basis of the known measuring systems, provision has already been made of devices for controlling the quantity of carbon and oxygen additionally injected, which, in the event of excessive foaming, reduce the quantity of carbon additionally injected to a minimum and adapt the quantity of oxygen added.

It has been found that an excessively large quantity of carbon monoxide is present over a certain time period in the off-gas of the electric arc furnace at the start of and during the phase of foamed slag formation, and this is expressed in a carbon monoxide peak or carbon monoxide bump and cannot be satisfactorily subsequently burnt. The carbon monoxide leaving an off-gas post-combustion plant again passes via the chimney into the environment.

In the past, the content of carbon monoxide and also carbon dioxide in the off-gas has been determined partially on the basis of a measurement in an off-gas duct downstream of the electric arc furnace and/or downstream of an off-gas post-combustion plant by means of gas sensors. On account of the high temperature of the off-gas prevailing at the measurement site and the considerable dust content thereof, such measurements do contain errors, however, and the service life of the measuring devices used for this purpose is limited. Furthermore, since the measurement is made in the off-gas duct, the development of the carbon monoxide in the furnace vessel is only detected with a certain time delay, and this results in a delayed control intervention. This has the effect that an excessively large quantity of carbon monoxide which cannot be satisfactorily subsequently burnt is briefly present in the off-gas. The carbon monoxide leaving the off-gas post-combustion plant again passes in turn via the chimney into the environment.

### SUMMARY

According to various embodiments, a process and an apparatus can be provided which make it possible to even out a carbon monoxide content in the off-gas of an electric arc furnace.

According to an embodiment, in a process for controlling a carbon monoxide emission of an electric arc furnace, which comprises a furnace vessel, an arrangement for determining a height of a foamed slag in at least three zones of the furnace vessel on the basis of a structure-borne noise measurement, at least one first device for controlling a supply of oxygen, and at least one second device for controlling an introduction of carbon into the furnace vessel, the height of the foamed slag is determined in each of the at least three zones and is associated with a carbon monoxide content in the off-gas of the electric arc furnace, wherein the introduction of carbon and/or the supply of oxygen in at least one of the at least three zones is controlled in such a manner that the height of the foamed slag is maintained below a maximum value.

According to a further embodiment, the height of the foamed slag can be furthermore maintained above a minimum value. According to a further embodiment, at least one first device can be assigned to each of the at least three zones and the supply of oxygen is controlled separately for each of the at least three zones. According to a further embodiment, at least one second device can be assigned to each of the at least three zones and the introduction of carbon is controlled separately for each of the at least three zones. According to a further embodiment, extrapolation can be used to predict a progression of the height of the foamed slag in each of the at least three zones and/or averaged over the at least three zones. According to a further embodiment, carbon monoxide contents measured in the off-gas can be used to predict a progression of the height of the foamed slag in each of the at least three zones and/or averaged over the at least three zones and to correlate measured values relating to the height of the foamed slag with carbon monoxide contents. According to a further embodiment, a reaction model stored on at least one computation unit can be used to predict a progression of the height of the foamed slag in each of the at least three zones and/or averaged over the at least three zones and to correlate measured values relating to the height of the foamed slag with carbon monoxide contents in the off-gas. According to a further embodiment, at least one fuzzy controller can be used to control the at least one first device and/or the at least one second device. According to a further embodiment, a current carbon monoxide content in the off-gas can be measured and compared with a nominal carbon monoxide content, and an attainment of the nominal carbon dioxide content is targeted by dynamically changing the maximum value. According to a further embodiment, the maximum value can be correlated with a permissible limit value for carbon monoxide. According to a further embodiment, after the height of the foamed slag in each of the at least three zones has been associated with a carbon monoxide content in the off-gas of the electric arc furnace, an off-gas post-combustion plant situated downstream of the electric arc furnace can be controlled on the basis of the associated carbon monoxide content.

According to another embodiment, an apparatus for controlling a carbon monoxide emission of an electric arc furnace, which comprises a furnace vessel and an arrangement for determining a height of a foamed slag in at least three zones of the furnace vessel on the basis of a structure-borne noise measurement, wherein the apparatus comprises at least one first device for controlling a supply of oxygen into the furnace vessel, at least one second device for controlling an introduction of carbon into the furnace vessel, and at least one computation unit for capturing measured values relating to the height of the foamed slag in each of the at least three zones, wherein the at least one computation unit is furthermore set up to associate the measured values with a carbon monoxide content in the off-gas of the electric arc furnace, to compare the measured values with a maximum value for the height of the foamed slag, and, if the maximum value is exceeded, to emit at least one control signal for at least the at least one first device and/or the at least one second device.

According to a further embodiment of the apparatus, the at least one computation unit can be furthermore set up to compare the measured values with a minimum value for the height of the foamed slag, and, if the minimum value is undershot, to emit at least one control signal for the at least one first device and/or the at least one second device. According to a further embodiment of the apparatus, at least one first device can be assigned to each of the at least three zones and the supply of oxygen can be controlled separately for each of the at least three zones. According to a further embodiment of the apparatus, at least one second device can be assigned to each of the at least three zones and the introduction of carbon can be controlled separately for each of the at least three zones. According to a further embodiment of the apparatus, the at least one computation unit can be set up to carry out extrapolation on the basis of the measured values to predict a progression of the height of the foamed slag in each of the at least three zones and/or averaged over the at least three zones. According to a further embodiment of the apparatus, carbon dioxide contents measured in the off-gas can be stored on the at least one computation unit to predict a progression of the height of the foamed slag and to correlate measured values relating to the height of the foamed slag with a carbon monoxide content in the off-gas. According to a further embodiment of the apparatus, a reaction model for predicting a progression of the height of the foamed slag and correlating measured values relating to the height of the foamed slag with a carbon monoxide content in the off-gas can be stored on the at least one computation unit. According to a further embodiment of the apparatus, the apparatus may comprise at least one fuzzy controller. According to a further embodiment of the apparatus, the at least one computation unit can be set up to compare carbon monoxide contents currently measured in the off-gas with a nominal carbon monoxide content stored on the at least one computation unit and to attain the nominal carbon dioxide content by means of a dynamic change of the maximum value. According to a further embodiment of the apparatus, the maximum value can be correlated with a permissible limit value for carbon monoxide. According to a further embodiment of the apparatus, the at least one computation unit can be set up, after the height of the foamed slag in each of the at least three zones has been associated with a carbon monoxide content in the off-gas of the electric arc furnace, to control operation of an off-gas combustion plant situated downstream of the electric arc furnace on the basis of the associated carbon monoxide content.

### BRIEF DESCRIPTION OF THE DRAWINGS

FIGS. 1 to 5 are intended to explain the various embodiment by way of example.

FIG. 1 shows an overview of a process sequence in the end phase of a melting operation in an electric arc furnace;

FIG. 2 shows a comparison between a process sequence in the end phase of a melting operation in an electric arc furnace as shown in FIG. 1 and a process sequence according to various embodiments in the end phase;

FIG. 3 schematically shows an electric arc furnace with an apparatus according to various embodiments;

FIG. 4 schematically shows a section through the furnace vessel of the electric arc furnace shown in FIG. 3; and

FIG. 5 shows a comparison of a carbon monoxide content in the off-gas CO_{off-gas} and a height of the foamed slag HS with and without control according to various embodiments.

### DETAILED DESCRIPTION

For the process for controlling a carbon monoxide emission of an electric arc furnace, which comprises a furnace vessel, an arrangement for determining a height of a foamed slag in at least three zones of the furnace vessel on the basis of a structure-borne noise measurement, at least one first device for controlling a supply of oxygen, and at least one second device for controlling an introduction of carbon into the furnace vessel, according to various embodiments, the height of the foamed slag is determined in each of the at least three zones and is associated with a carbon monoxide content in the off-gas of the electric arc furnace, and in that the introduction of carbon and/or the supply of oxygen in at least one of the at least three zones is controlled in such a manner that the height of the foamed slag is maintained below a maximum value.

For the apparatus for controlling a carbon monoxide emission of an electric arc furnace, according to various embodiments, which comprises a furnace vessel and an arrangement for determining a height of a foamed slag in at least three zones of the furnace vessel on the basis of a structure-borne noise measurement, the apparatus comprises at least one first device for controlling a supply of oxygen into the furnace vessel, at least one second device for controlling an introduction of carbon into the furnace vessel, and at least one computation unit for capturing measured values relating to the height of the foamed slag in each of the at least three zones, wherein the at least one computation unit is furthermore set up to associate the measured values with a carbon monoxide content in the off-gas of the electric arc furnace, to compare the measured values with a maximum value for the height of the foamed slag, and, if the maximum value is exceeded, to emit at least one control signal for at least the at least one first device and/or the at least one second device.

The process and the apparatus according to various embodiments make it possible to even out a carbon monoxide content in the off-gas of an electric arc furnace. Since the height of the foamed slag in the electric arc furnace is a measure of the quantity of carbon monoxide and carbon dioxide formed, it is possible to use the measurement of the height of the foamed slag directly for controlling the carbon monoxide emission of the electric arc furnace. Since a height of the foamed slag can be determined particularly quickly and accurately in at least three zones of the furnace vessel on the basis of a structure-borne noise measurement, the at least one first and/or the at least one second device can be controlled particularly quickly and without a notable time delay.

Since the carbon monoxide content in the off-gas is evened out, it is possible to completely or almost completely subsequently burn the carbon monoxide present in the off-gas in an off-gas post-combustion plant, which is usually situated downstream of an electric arc furnace. The proportion of carbon monoxide which escapes via the chimney into the environment is reduced to zero or virtually zero or at least greatly reduced. The exposure of the environment to pollutants is lowered significantly.

Furthermore, it is possible to reduce the quantity of carbon to be introduced and/or oxygen to be supplied and to save costs.

With respect to the determination of the height of the foamed slag in the at least three zones of the furnace vessel on the basis of a structure-borne noise measurement, reference is made to DE 10 2005 034 409 B3, which describes the measurement method used here in detail.

The maximum value here can be set permanently to a value over time, pass through a plurality of predetermined stages or be adapted dynamically to the current conditions.

Further configurations of the process and of the apparatus according to various embodiments are indicated below.

The height of the foamed slag is furthermore preferably maintained above a minimum value. A minimum quantity of foamed slag ensures an optimum introduction of energy into the melt and a reduction in the heat dissipated from the surface of the melt. To date, therefore, even when a minimum value for the height of the foamed slag was reached, the at least one second device for controlling an introduction of carbon into the furnace vessel was controlled in such a manner as to minimize the introduction of carbon. The observance of the minimum value and also of the maximum value for the height of the foamed slag leads to a further evening out of the carbon monoxide content in the off-gas and to more effective utilization of a possibly present off-gas post-combustion plant.

The at least one computation unit of the apparatus is set up, in particular, to compare the measured values relating to the height of the foamed slag with the minimum value for the height of the foamed slag, and, if the minimum value is undershot, to emit at least one control signal for the at least one first device and/or the at least one second device.

At least one first device is preferably assigned to each of the at least three zones of the electric arc furnace and the supply of oxygen is controlled separately for each of the at least three zones. It is thus possible to counteract local excessive foaming of the foamed slag in a targeted manner by reducing the quantity of oxygen added in this region. If the foamed slag height is too low, by contrast, the quantity of oxygen added is increased and the foam formation is thereby encouraged.

Here, pure oxygen, air, water vapor or combinations thereof have proved to be suitable as materials suitable for the introduction of oxygen into the furnace vessel. An addition of iron oxide, preferably in the form of iron ore, as oxygen supplier can also be provided.

Furthermore, at least one second device is assigned to each of the at least three zones and the introduction of carbon is controlled separately for each of the at least three zones. It is thus possible to counteract local excessive foaming of the foamed slag in a targeted manner by reducing the quantity of carbon introduced in this region. If the foamed slag height is too low, by contrast, the quantity of carbon introduced can be increased and the foam formation can thereby be encouraged. Here, the carbon is preferably introduced in a pulsed manner.

Here, materials suitable for the introduction of carbon by means of injection into the furnace vessel have proved to be various coals, coke, wood, iron carbide, direct reduced iron, hot-briquetted iron, ore, filter dust, scale, dried and comminuted slurry, a slag former such as lime, limestone, dolomite, fluorite and the like, the carbon being introduced in comminuted form or as a powder.

In this case, it is particularly preferable to use in each case at least one first device and at least one second device for each of the designated zones of the furnace vessel, in order to be able to influence the foamed slag formation as quickly and dynamically as possible.

Extrapolation is preferably used to predict a progression of the height of the foamed slag in each of the at least three zones and/or averaged over the at least three zones. From the temporal progression of the foamed slag height of a zone, it is possible to counteract excessive or insufficient foaming in good time and to reliably ensure that the carbon monoxide content in the off-gas of the electric arc furnace is evened out, with the introduction of energy being optimal at the same time. The dead time between the detection of an insufficient or excessive foamed slag state in the furnace vessel and a control intervention is reduced significantly, and it is possible to have an influence in the process environment.

The at least one computation unit of the apparatus is preferably set up to carry out the extrapolation on the basis of the measured values relating to the height of the foamed slag to predict a progression of the height of the foamed slag in each of the at least three zones and/or averaged over the at least three zones.

As an alternative or in combination, carbon dioxide contents measured in the off-gas are used to predict a progression of the height of the foamed slag in each of the at least three zones and/or averaged over the at least three zones and to correlate measured values relating to the height of the foamed slag with carbon monoxide contents.

As an alternative or in combination, a reaction model stored on the at least one computation unit can be used to predict a progression of the height of the foamed slag in each of the at least three zones and/or averaged over the at least three zones and to correlate measured values relating to the height of the foamed slag with carbon monoxide contents. The reaction model is based here preferably on theoretical calculations relating to the off-gas formation, which are preferably stored in combination with empirical values relating to the off-gas formation for an electric arc furnace and/or the material to be melted and/or the melting program used. If a reaction model is created, the composition of the melt, the temperature of the melt, the quantity of off-gas produced, the site and the quantity of foamed slag formation etc. are preferably to be taken into consideration. In particular, it is advantageous if the reaction model can continuously be optimized during operation of the electric arc furnace on the basis of measured values and plant parameters, which can be captured, preferably automatically, by the at least one computation unit, and, if appropriate, can also be complemented manually by the operating personnel by way of an input unit.

At least one fuzzy controller, in particular a neurofuzzy controller, is preferably used to control the at least one first device and/or the at least one second device. Fuzzy controllers are systems which belong to the class of the characteristic map controllers, which correspond to the theory of fuzzy logic. In each control step, three substeps are carried out: fuzzification, inference and finally defuzzification. The individual inputs and outputs are designated as linguistic variables, to which fuzzy sets respectively belong.

Here, for example, such a fuzzy controller can draw on a reaction model, as already mentioned above, stored in the computation unit.

Dynamic control can be effected in the different phases of a melting operation, in particular in the phase of foamed slag formation, on the basis of different minimum and/or maximum values for the height of the foamed slag. The foamed slag phase denotes a time period, after all the metallic constituents have been melted in the furnace chamber, in which the melt is reduced and/or decarburized.

In a configuration of the process, a current carbon monoxide content in the off-gas is measured and compared with a nominal carbon monoxide content in the off-gas. Here, such a nominal carbon monoxide content denotes, in particular, that quantity of carbon monoxide in the off-gas which can be subsequently burnt optimally by an off-gas post-combustion plant situated downstream of the electric arc furnace. So that this nominal carbon dioxide content is achieved as continuously as possible, it has proved to be expedient to accordingly change or adapt the maximum value dynamically. This makes it possible to optimally utilize the capacity of an off-gas post-combustion plant.

The at least one computation unit of the apparatus is set up, in particular, to compare carbon monoxide contents currently measured in the off-gas with a nominal carbon monoxide content stored on the at least one computation unit and to dynamically change the maximum value in order to attain the nominal carbon dioxide content. A maximum value set in advance can thereby be corrected and adapted dynamically to current or changing plant conditions.

The maximum value can be correlated with a permissible limit value for carbon monoxide, which is based on a legal regulation. Here, the maximum value is selected in particular such that an off-gas subsequently burnt by means of an off-gas post-combustion plant situated downstream of the electric arc furnace emits to the environment at most a residual quantity of carbon monoxide per unit of time which is below a permissible limit value.

In a further, configuration of the process, after the height of the foamed slag in each of the at least three zones has been associated with a carbon monoxide content in the off-gas of the electric arc furnace, the operation of an off-gas combustion plant situated downstream of the electric arc furnace is controlled on the basis of the associated carbon monoxide content. In this case, the quantity of oxygen injected into the off-gas combustion plant can be influenced, for example by controlling a discharge of fresh-air fans and/or of gas valves, in such a manner that, given a relatively high carbon monoxide content in the off-gas downstream of the electric arc furnace, an accordingly larger quantity of oxygen is provided for subsequently burning it.

The at least one computation unit of the apparatus is preferably set up, after the height of the foamed slag in each of the at least three zones has been associated with a carbon monoxide content in the off-gas of the electric arc furnace, to control operation of an off-gas post-combustion plant situated downstream of the electric arc furnace on the basis of the associated carbon monoxide content.

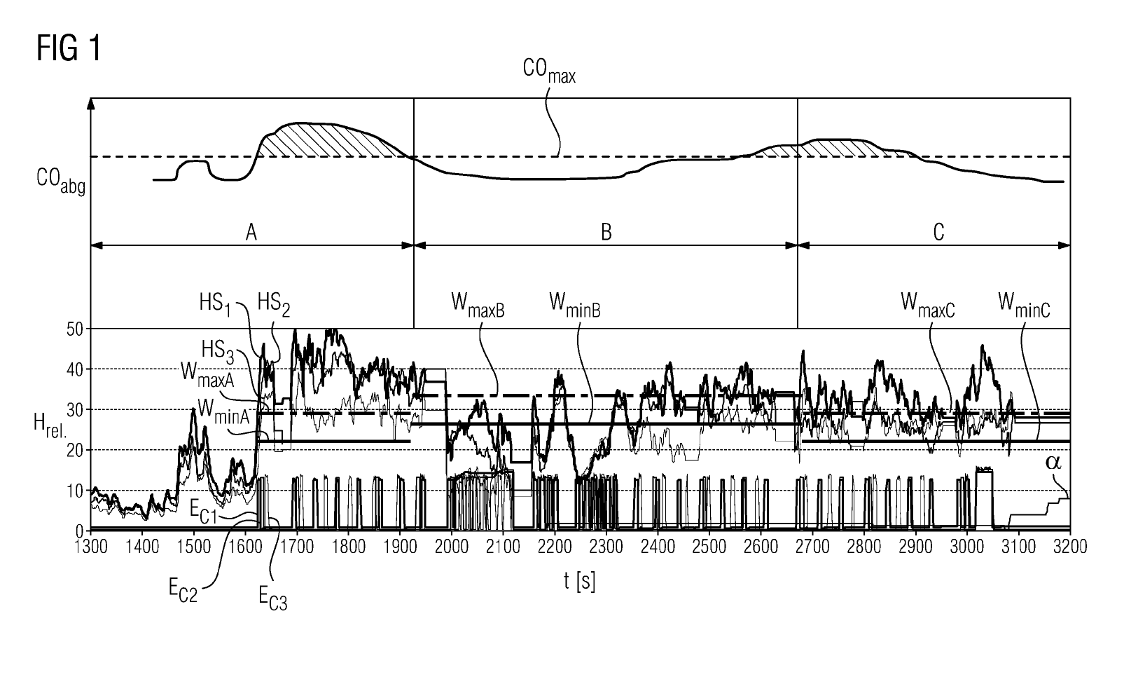

FIG. 1 shows an overview of a process sequence in the end phase of a melting operation in an electric arc furnace. Above the X axis, which indicates the time t in seconds since the start of the melting operation, the Y axis plots, with H_{rel.}, a tilt angle α of a furnace vessel of an electric arc furnace, a height of the foamed slag HS₁, HS₂, HS₃ for in each case one of three zones of the furnace vessel, and also a carbon introduction quantity E_{C1}, E_{C2}, E_{C3} for each of the three zones of the furnace vessel. Here, the end of the scrap melting phase and the start of the foamed slag phase are denoted by A, the middle region of the foamed slag phase is denoted by B, and the end phase of the foamed slag phase just before the melt is cast is denoted by C.

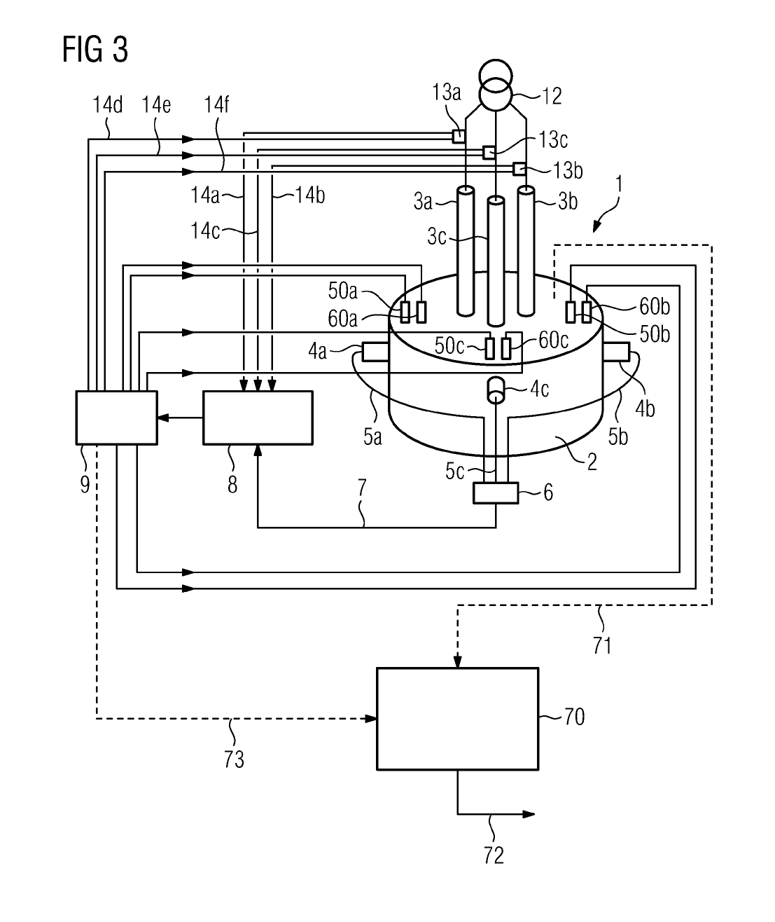

The height of the foamed slag HS₁, HS₂, HS₃ in the three zones of the furnace vessel 1a of the electric arc furnace 1 is determined by means of a structure-borne noise measurement. Each zone of the furnace vessel 1a is provided with a first device 50a, 50b, 50c for controlling the supply of oxygen and a second device 60a, 60b, 60c for controlling an introduction of carbon E_{C1}, E_{C2}, E_{C3} into the furnace vessel 1a (cf. in this respect FIG. 3).

A maximum value W_{maxA}, W_{maxB}, W_{maxC} and a minimum value W_{minA}, W_{minB}, W_{minC} for the height of the foamed slag in the furnace vessel are respectively plotted in phases A to C. To date, the carbon monoxide emission CO_{off-gas} of the electric arc furnace 1 was insufficiently controlled in phases A to C. The height of the foamed slag HS₁, HS₂, HS₃ far exceeds, in particular in phase A, the minimum value W_{minA} and furthermore the maximum value W_{maxA}, and has the effect that a value COₘₐₓ for a desired carbon monoxide content or a nominal carbon monoxide content in the off-gas is exceeded (see the hatched areas in the CO_{off-gas} behavior). In phases B and C, too, however, a value COₘₐₓ for a desired carbon monoxide content or a nominal carbon monoxide content in the off-gas can be exceeded. An off-gas post-combustion plant 70 situated downstream of the electric arc furnace 1 cannot adequately subsequently burn the large quantity of carbon monoxide incoming, and therefore an undesirable quantity of carbon monoxide remains in the off-gas and passes into the environment.

Here, the maximum value W_{maxA}, W_{maxB}, W_{maxC} can be correlated with a permissible limit value for carbon monoxide in the subsequently burnt off-gas, which is discharged via the chimney into the environment.

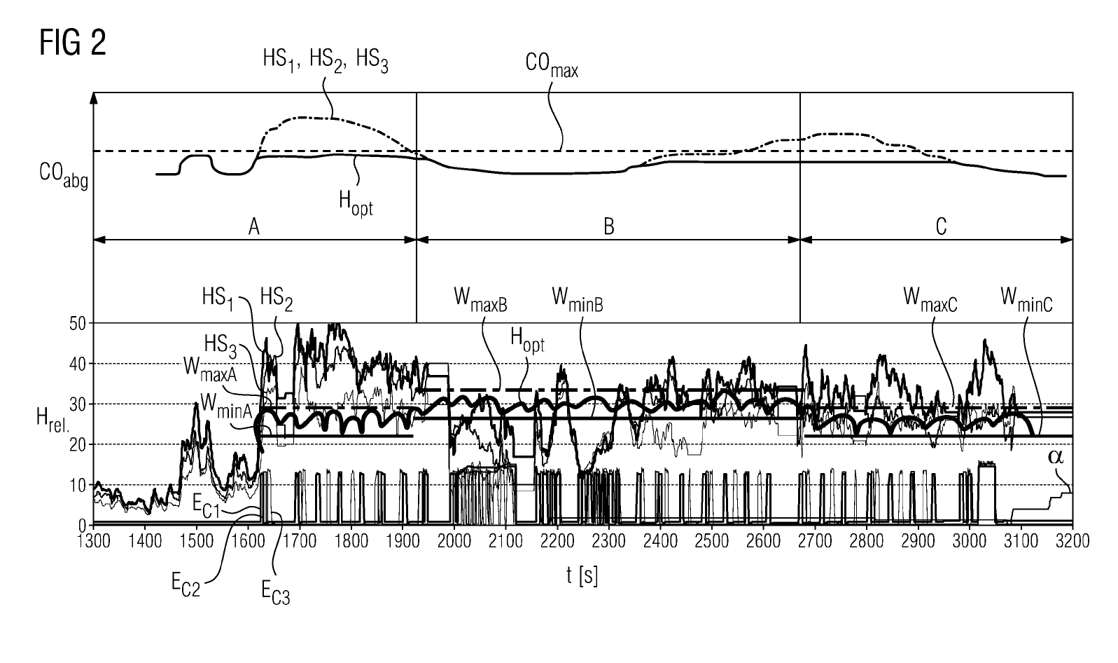

FIG. 2 shows a comparison between a process sequence shown in FIG. 1 and a process sequence according to various embodiments in the end phase of a melting process. The curves for the determined height of the foamed slag HS₁, HS₂, HS₃ as shown in FIG. 1 are again shown in the three phases A, B, C, as is the associated progression of the carbon monoxide content in the off-gas CO_{off-gas} (see dash-dotted line in the CO_{off-gas} behavior).

FIG. 2 also shows a curve showing the height of the foamed slag Hₒₚₜ. on average with the supply of oxygen and the introduction of carbon E_{C1}, E_{C2}, E_{C3} being controlled according to various embodiments. The maximum values W_{maxA}, W_{maxB}, W_{maxC} in phases A, B, C for the height of the foamed slag are no longer exceeded here for all three zones of the furnace vessel 1a. As a result, if the height of the foamed slag progresses according to the curve H_{opt.}, a progression which is consistently below the value COₘₐₓ is formed for the carbon monoxide content in the off-gas CO_{off-gas} (see the bold line in the CO_{off-gas} behavior). In phase A and the transition region between phases B and C, the carbon monoxide emission of the electric arc furnace is reduced, and the value COₘₐₓ is no longer exceeded. The CO emission of the electric arc furnace is then at a uniform level and can be burnt uniformly by the off-gas post-combustion plant usually situated downstream of the electric arc furnace.

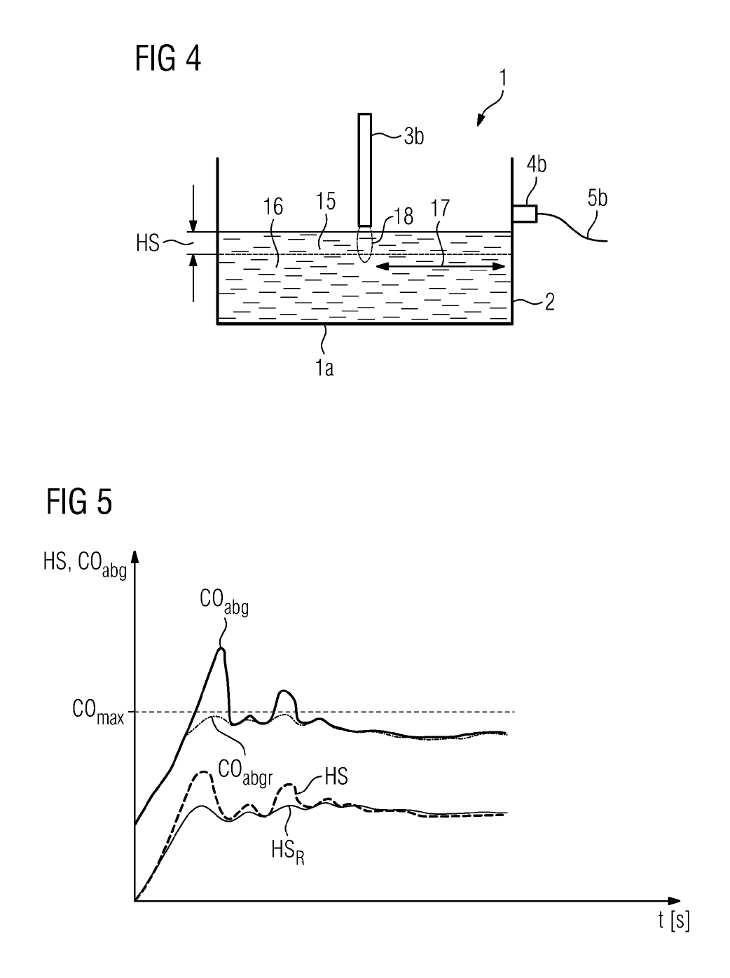

FIG. 3 shows an electric arc furnace 1 with a furnace vessel 1a, into which a plurality of electrodes 3a, 3b, 3c coupled to a power supply device 12 by way of power supply lines are routed. The power supply device 12 preferably has a furnace transformer. With the aid of at least one of the three electrodes 3a, 3b, 3c, charging materials, such as for example scrap and further additives, are melted in the electric arc furnace 1. The production of steel in the electric arc furnace 1 forms slag or foamed slag 15 (see FIG. 4), as a result of which the introduction of energy by means of an arc 18 (see FIG. 4), which forms on the at least one electrode 3a, 3b, 3c, into the melt is improved.

In the exemplary embodiment shown in FIG. 3, sensor and control devices 13a, 13b, 13c are provided on the power supply lines of the electrodes 3a, 3b, 3c, and can be used to measure and control current and/or voltage or the energy supplied to the electrodes 3a, 3b, 3c. The sensor and control devices 13a, 13b, 13c capture the current and/or voltage signals preferably in a time-resolved manner. The sensor and control devices 13a, 13b, 13c are coupled to a computation unit 8, for example via signal lines 14a, 14b, 14c in the form of cables. Further signal lines 14d, 14e, 14f serve to connect the sensor and control devices 13a, 13b, 13c to a control device 9, which receives the control demands from the computation unit 8.

Structure-borne noise sensors 4a, 4b, 4c for measuring oscillations are arranged on the wall 2 of the furnace vessel 1a, i.e. on the outer enclosure of the furnace vessel 1a. The structure-borne noise sensors 4a, 4b, 4c may be connected indirectly and/or directly to the furnace vessel 1a or to the wall 2 of the furnace vessel 1a. The structure-borne noise sensors 4a, 4b, 4c are preferably arranged on those sides of the wall 2 of the electric arc furnace 1 which are located opposite the electrodes 3a, 3b, 3c. Here, the structure-borne noise sensors 4a, 4b, 4c are preferably formed as acceleration sensors and positioned above the foamed slag 15 (see FIG. 4). The structure-borne noise sensors 4a, 4b, 4c are likewise connected to the computation unit 8.

The measured values or signals transmitted from the structure-borne noise sensors 4a, 4b, 4c to the computation unit 8 are conducted via protected lines 5a, 5b, 5c into an optical device 6, and at least some of said values or signals are conducted from the latter in the direction of the computation unit 8 via an optical waveguide 7. The signal lines 5a, 5b, 5c are preferably routed in such a way that they are protected from heat, electromagnetic fields, mechanical loading and/or other loads.

The optical device 6 serves for amplifying and/or converting signals of the structure-borne noise sensors 4a, 4b, 4c and is preferably arranged relatively close to the electric arc furnace 1. In the optical device 6, the measured values or signals of the structure-borne noise sensors 4a, 4b, 4c are converted into optical signals and transmitted via the optical waveguide 7 free from interference over relatively longer distances, e.g. 50 to 200 m, to the computation unit 8.

Here, each zone of the furnace vessel 1a is provided with a first device 50a, 50b, 50c for controlling the supply of oxygen and a second device 60a, 60b, 60c for controlling an introduction of carbon E_{C1}, E_{C2}, E_{C3} (cf. FIGS. 1 and 2) into the furnace vessel 1a, and these devices are controlled according to various embodiments by means of the computation unit 8 and the control device 9 in such a manner that a maximum value W_{maxA}, W_{maxB}, W_{maxC} in phases A, B, C (cf. FIG. 2) for the height of the foamed slag 15 is not exceeded for all three zones of the furnace vessel 1a or on average over the three zones. Furthermore, the devices are controlled in such a manner that a minimum value W_{minA}, W_{minB}, W_{minC} in phases A, B, C (cf. FIG. 2) for the height of the foamed slag 15 is not undershot for all three zones of the furnace vessel 1a or on average over the three zones, such that an optimum introduction of energy into the electric arc furnace 1 is ensured.

In the computation unit 8, the measured values or signals of the structure-borne noise sensors 4a, 4b, 4c and of the sensor and control devices 13a, 13b, 13c are captured and evaluated in order to determine the height of the foamed slag 15 (see FIG. 4) in the furnace vessel 1a. The measured values or signals determined by the structure-borne noise sensors 4a, 4b, 4c are correlated with the height of the foamed slag 15, in which case a time resolution in the range of about 1 to 2 seconds is possible. In the computation unit 8, the measured values or signals which indicate the height of the foamed slag 15 in the furnace vessel 1a for each zone are associated with an associated carbon monoxide content in the off-gas of the electric arc furnace 1. In the computation unit 8, the associated carbon monoxide content is compared with a value COₘₐₓ for carbon monoxide in the off-gas which corresponds to a desired carbon monoxide quantity or a nominal carbon monoxide quantity, and the introduction of carbon and/or the supply of oxygen is accordingly corrected if required. If appropriate, an intervention in addition to the change in the temperature and/or composition of the melt can also be made.

Therefore, depending on the associated carbon monoxide content, the first devices 50a, 50b, 50c and/or the second devices 60a, 60b, 60c are used to control, in particular, the introduction of carbon and/or the supply of oxygen in one or more of the zones of the furnace vessel 1a in such a manner that the height of the foamed slag on average or in the respective zone is maintained below the maximum value W_{maxA}, W_{maxB}, W_{maxC} and also exceeds the minimum value W_{minA}, W_{minB}, W_{minC}. The computation unit 8 passes at least one control signal or a control command, on the basis of the currently calculated and/or precalculated height of the foamed slag for each zone in the furnace vessel 1a or averaged over the zones, on to the control device 9.

In accordance with the computation unit 8, and if appropriate also on the basis of its own calculations, the control device 9 further controls, in addition to the introduction of carbon and/or the supply of oxygen, if appropriate, a supply of further materials into the furnace vessel 1a and also an introduction of energy via the electrodes 3a, 3b, 3c. The control device 9 preferably comprises a fuzzy controller.

An off-gas post-combustion plant 70 is optionally situated downstream of the electric arc furnace 1 and subsequently burns the off-gas coming from the electric arc furnace 1 via an off-gas line 71 and then discharges it via a chimney 72 to the environment. Such an off-gas post-combustion plant 70 can be controlled here via a control line 73 from the control device 9, which receives a corresponding control signal preferably from the computation unit 8.

FIG. 4 is a simplified illustration showing one of the electrodes 3b with an arc 18 in a furnace vessel 1a of an electric arc furnace 1. The structure-borne noise sensor 4b is arranged on the wall 2 of the furnace vessel 1a and is connected to the signal line 5b, with the aid of which signals are transmitted to the computation unit 8 (see FIG. 3).

FIG. 4 schematically shows the melt bath 16 and the foamed slag 15 in a cross section of the furnace vessel 1a. The height HS of the foamed slag 15 can be determined in the computation unit 8 with the aid of a transmission function of the structure-borne noise in the electric arc furnace 1. The transmission function characterizes the transmission path 17 of the structure-borne noise from excitation up to the detection site, as indicated schematically in FIG. 4. The structure-borne noise is excited by the power feed at the electrodes 3b in the arc 18. The structure-borne noise, i.e. the oscillations caused by the excitation, is transmitted by the melt bath 16 and/or by the foamed slag 15 at least partially covering the melt bath 16 to the wall 2 of the furnace vessel 1a. Structure-borne noise can also be transmitted at least partially additionally by as yet unmelted charging material in the electric arc furnace 1.

The evaluation of the measured values or signals in the computation unit 8 can be continuously optimized with the aid of empirical values from the operation of the electric arc furnace 1. The signals are captured and evaluated and the slag height is determined online during operation, such that the foamed slag height ascertained in the electric arc furnace 1 can be used to automatically control the carbon monoxide emission of the electric arc furnace 1.

The rapid and direct detection of the height of the foamed slag in the furnace vessel 1a makes improved process monitoring and control possible, which ensures at all times an evening out of the carbon monoxide content in the off-gas of an electric arc furnace and, if appropriate, ensures optimum subsequent burning of the carbon monoxide.

FIG. 5 shows a comparison of a carbon monoxide content in the off-gas CO_{off-gas} and a height of the foamed slag HS over time t in the foamed slag phase of a melting process in an electric arc furnace with and without control according to various embodiments. Without the height of the associated foamed slag HS being controlled to a maximum value, the carbon monoxide content in the off-gas CO_{off-gas} exceeds a value COₘₐₓ. If the height of the foamed slag HS_{C} is controlled in such a manner that a maximum value is not exceeded, the carbon monoxide content in the off-gas CO_{off-gasc} no longer exceeds the desired value COₘₐₓ, and the carbon monoxide content in the off-gas is evened out or maintained at a largely constant level.

Here, FIGS. 1 to 5 merely show examples which may turn out to be very different with differing melting programs, electric arc furnaces, etc. With knowledge of various embodiments, however, a person skilled in the art is readily able, possibly after carrying out a few tests, to also control the carbon monoxide emission for electric arc furnaces of differing design or with different equipment with the assistance of the determination of a height of a foamed slag in at least three zones of the furnace vessel on the basis of a structure-borne noise measurement.

What is claimed is:

1. A process for controlling a carbon monoxide emission of an electric arc furnace, which comprises a furnace vessel, an arrangement for determining a height of a foamed slag in at least three zones of the furnace vessel on the basis of a structure-borne noise measurement, at least one first device for controlling a supply of oxygen, and at least one second device for controlling an introduction of carbon into the furnace vessel, the process comprising the steps:
determining the height of the foamed slag in each of the at least three zones and associating the height with a carbon monoxide content in the off-gas of the electric arc furnace, and
controlling the introduction of at least one of carbon and the supply of oxygen in at least one of the at least three zones in such a manner that the height of the foamed slag is maintained below a maximum value.

2. The process according to claim 1,
wherein the height of the foamed slag is furthermore maintained above a minimum value.

3. The process according to claim 1,
wherein at least one first device is assigned to each of the at least three zones and the supply of oxygen is controlled separately for each of the at least three zones.

4. The process according to claim 1,
wherein at least one second device is assigned to each of the at least three zones and the introduction of carbon is controlled separately for each of the at least three zones.

5. The process according to claim 1,
wherein extrapolation is used to predict a progression of the height of the foamed slag in at least one of each of the at least three zones and/or averaged over the at least three zones.

6. The process according to claim 1,
wherein carbon monoxide contents measured in the off-gas are used to predict a progression of the height of the foamed slag in at least one of each of the at least three zones and averaged over the at least three zones and to correlate measured values relating to the height of the foamed slag with carbon monoxide contents.

7. The process according to claim 1,
wherein a reaction model stored on at least one computation unit is used to predict a progression of the height of the foamed slag in at least one of each of the at least three zones and/or averaged over the at least three zones and to correlate measured values relating to the height of the foamed slag with carbon monoxide contents in the off-gas.

8. The process according to claim 1,
wherein at least one fuzzy controller is used to control the at least one first device and/or the at least one second device.

9. The process according to claim 1,
wherein a current carbon monoxide content in the off-gas is measured and compared with a nominal carbon monoxide content, and an attainment of the nominal carbon dioxide content is targeted by dynamically changing the maximum value.

10. The process according to claim 1,
wherein the maximum value is correlated with a permissible limit value for carbon monoxide.

11. The process according to claim 1,
wherein, after the height of the foamed slag in each of the at least three zones has been associated with a carbon monoxide content in the off-gas of the electric arc furnace, an off gas post-combustion plant situated downstream of the electric arc furnace is controlled on the basis of the associated carbon monoxide content.

12. An apparatus for controlling a carbon monoxide emission of an electric arc furnace, which comprises a furnace vessel and an arrangement for determining a height of a foamed slag in at least three zones of the furnace vessel on the basis of a structure-borne noise measurement, wherein the apparatus comprises at least one first device for controlling a supply of oxygen into the furnace vessel, at least one second device for controlling an introduction of carbon into the furnace vessel, and at least one computation unit for capturing measured values relating to the height of the foamed slag in each of the at least three zones, wherein the at least one computation unit is furthermore set up to associate the measured values with a carbon monoxide content in the off-gas of the electric arc furnace, to compare the measured values with a maximum value for the height of the foamed slag, and, if the maximum value is exceeded, to emit at least one control signal for at least one of the at least one first device and the at least one second device.

13. The apparatus according to claim 12,
wherein the at least one computation unit is furthermore set up to compare the measured values with a minimum value for the height of the foamed slag, and, if the minimum value is undershot, to emit at least one control signal for the at least one of the at least one first device and the at least one second device.

14. The apparatus according to claim 12,
wherein at least one first device is assigned to each of the at least three zones and the supply of oxygen can be controlled separately for each of the at least three zones.

15. The apparatus according to claim 12,
wherein at least one second device is assigned to each of the at least three zones and the introduction of carbon can be controlled separately for each of the at least three zones.

16. The apparatus according to claim 12,
wherein the at least one computation unit is set up to carry out extrapolation on the basis of the measured values to predict a progression of the height of the foamed slag in each of at least one of the at least three zones and averaged over the at least three zones.

17. The apparatus according to claim 12,
wherein carbon dioxide contents measured in the off-gas are stored on the at least one computation unit to predict a progression of the height of the foamed slag and to correlate measured values relating to the height of the foamed slag with a carbon monoxide content in the off-gas.

18. The apparatus according to claim 12,
wherein a reaction model for predicting a progression of the height of the foamed slag and correlating measured values relating to the height of the foamed slag with a carbon monoxide content in the off-gas is stored on the at least one computation unit.

19. The apparatus according to claim 12,
wherein the apparatus comprises at least one fuzzy controller.

20. The apparatus according to claim 12,
wherein the at least one computation unit is set up to compare carbon monoxide contents currently measured in the off-gas with a nominal carbon monoxide content stored on the at least one computation unit and to attain the nominal carbon dioxide content by means of a dynamic change of the maximum value.

21. The apparatus according to claim 12,
wherein the maximum value is correlated with a permissible limit value for carbon monoxide.

22. The apparatus according to claim 12,
wherein the at least one computation unit is set up, after the height of the foamed slag in each of the at least three zones has been associated with a carbon monoxide content in the off-gas of the electric arc furnace, to control operation of an off-gas combustion plant situated downstream of the electric arc furnace on the basis of the associated carbon monoxide content.
